(19) United States
(12) Patent Application Publication
(10) Pub. No.: US 2025/0046122 A1
(43) Pub. Date: Feb. 6, 2025

(54) ELECTRONIC DEVICE AND METHODS FOR OUT OF FIELD OF VIEW HAND TRACKING

(71) Applicant: SAMSUNG ELECTRONICS CO., LTD., Suwon-si (KR)

(72) Inventors: Vishakha S R, Bangalore (IN); Bindigan Hariprasanna Pawan Prasad, Bangalore (IN); Green Rosh K S, Bangalore (IN); Akula Jayaprakash, Bangalore (IN); Meghana Shankar, Bangalore (IN); Prateek Kukreja, Bangalore (IN); Shubham Mallik Thakur, Bangalore (IN); Sagar Parmar, Bangalore (IN); Mukesh Jha, Bangalore (IN); Sungsoo Choi, Suwon-si (KR); Hyuntaek Woo, Suwon-si (KR); Chaeeun Lee, Suwon-si (KR); Beomsu Kim, Suwon-si (KR)

(73) Assignee: SAMSUNG ELECTRONICS CO., LTD., Suwon-si (KR)

(21) Appl. No.: 18/907,042

(22) Filed: Oct. 4, 2024

Related U.S. Application Data
(63) Continuation of application No. PCT/KR2024/011420, filed on Aug. 2, 2024.

(30) Foreign Application Priority Data
Aug. 4, 2023 (IN) 202341052639
Jul. 8, 2024 (IN) 202341052639

(51) Int. Cl. G06V 40/20; A63F 13/213; A63F 13/428; G06F 3/01; G06V 10/75; G06V 10/77

(52) U.S. Cl. CPC G06V 40/28; A63F 13/213; A63F 13/428; G06V 10/751; G06V 10/7715; G06F 3/017

(57) ABSTRACT

There is provided a method and apparatus for performing gesture recognition in an electronic device, including: tracking a visible trajectory of a hand of a user from a plurality of frames captured by the electronic device, identifying, by the electronic device, a first frame where the hand of the user has gone out of a Field of View (FOV) of the electronic device, identifying the second frame where the hand of the user has come back into the FOV, predicting, using an Artificial Intelligence (AI) model, a trajectory of the hand of the user using one or more frames captured before the first frame, and one or more frames captured after the second frame, and recognizing at least one hand gesture performed during the visible trajectory of the hand of the user, and the predicted trajectory of the hand of the user.

### CROSS REFERENCE TO RELATED APPLICATION

This application is a continuation of International Application PCT/KR2024/011420, filed Aug. 2, 2024, and claims foreign priority to Indian Provisional Patent Application 20/234,1052639, filed on Aug. 4, 2023, and Indian Patent Application number 202341052639, filed on Jul. 8, 2024, the contents of which are incorporated herein by reference in their entireties.

### TECHNICAL FIELD

Embodiments disclosed herein relate to human interaction with electronic device(s) using gestures, and more particularly to out of field of view hand tracking using spatio-temporal outward and inward convergence.

### BACKGROUND

Hand gestures are the primary mode of feedback and interaction for devices, such as a Head Mounted Displays (HMDs). Thus, hand tracking is of utmost importance for HMD interactions as well as Augmented Reality (AR)/Virtual Reality (VR) applications. A challenging part about hand tracking is that a user's hand is not always in the field of view of the cameras. Existing algorithms usually reset when the hand goes out of view and begin tracking once the hand is back in the field of view. A disadvantage in using the above algorithms is that the hand gesture recognition systems typically need the hand to be present in all the frames for achieving accurate gesture recognition.

### SUMMARY

According to aspects of the disclosure, there is provided a method for performing gesture recognition in an electronic device, the method including: tracking, by the electronic device, a visible trajectory of a hand of a user from a plurality of frames captured by the electronic device; identifying, by the electronic device, the first frame where the hand of the user has gone out of a Field of View (FOV) of the electronic device, among the plurality of frames; identifying, by the electronic device, the second frame where the hand of the user has come back into the FOV of the electronic device, among the plurality of frames; obtaining, by the electronic device, using an Artificial Intelligence (AI) model, a trajectory of the hand of the user using the one or more frames captured before the first frame, among the plurality of frames and the one or more frames captured after the second frame, among the plurality of frames; and recognizing, by the electronic device, at least one hand gesture performed during the visible trajectory of the hand of the user, and the obtained trajectory of the hand of the user.

The method may also include: selecting, by the electronic device, a frame with the presence of the hand of the user from the visible trajectory, among the plurality of frames; and generating, by the electronic device, references of one or more hand landmarks from the frame with the presence of the hand of the user.

The method may also include: estimating, by the electronic device, a location of the one or more hand landmarks of the one or more frames captured before the first frame, based on the generated references of the one or more hand landmarks; calculating, by the electronic device, one or more kinetic parameters of each hand landmark, using the estimated location of the one or more hand landmarks of consecutive frames, wherein the consecutive frames include the one or more frames captured before the first frame; and obtaining, by the electronic device, a first trajectory of the hand of the user corresponding to the one or more frames captured before the first frame, using the calculated one or more kinetic parameters of each of the one or more hand landmarks.

The method may also include: reversing, by the electronic device, order of the plurality of frames captured by the electronic device; estimating, by the electronic device, a location of the one or more hand landmarks of the one or more frames captured after the second frame, based on the generated references of the one or more hand landmarks; calculating, by the electronic device, one or more kinetic parameters of each hand landmark, using the estimated location of the one or more hand landmarks of consecutive frames, wherein the consecutive frames include the one or more frames captured after the second frame; and obtaining, by the electronic device, a second trajectory of the hand of the user using the one or more frames captured after the second frame, using the calculated one or more kinetic parameters of each of the one or more hand landmarks.

The one or more kinetic parameters of the hand of the user may include at least one of a velocity and an acceleration of each of the one or more hand landmarks.

The method may also include: verifying, by the electronic device, if the hand of the user is in the FOV of the electronic device, after calculating one or more kinetic parameters of each of the one or more hand landmarks; and calculating, by the electronic device, a velocity and a position of the one or more hand landmarks in a next frame after the one or more frames captured after the second frame, using the calculated one or more kinetic parameters of each of the one or more hand landmarks, if the hand of the user is not in the FOV of the electronic device.

The method may also include: verifying, by the electronic device, at least one parameter of the hand of the user, after calculating the velocity and the position of the one or more hand landmarks in the next frame, wherein the at least one parameter includes at least one of whether a velocity goes to zero, a hand position is beyond a threshold, and the one or more hand landmarks no longer conform to predetermined bio-mechanical constraints of a human hand; repeating, by the electronic device, a verification of the hand of the user in the FOV of the electronic device, if the at least one parameter of the hand of the user is not satisfied; and repeating, by the electronic device, estimation of the location of the one or more hand landmarks from a previous frame previous to the next frame, if the hand of the user is stationary and the at least one parameter of the hand of the user is satisfied.

The method may also include: checking, by the electronic device, closeness of the one or more hand landmarks for each frame, of the plurality of frames, from the first trajectory and the second trajectory of the hand of the user; obtaining, by the electronic device, a spatio-temporal convergence at a frame, of the plurality of frames, where a distance between two extrapolated hand landmarks is below a certain threshold, wherein a trajectory until the frame of the spatio-temporal convergence is considered as the first trajectory, wherein a trajectory after the frame of the spatio-temporal convergence is considered as the second trajectory; estimating, by the electronic device, a hand pose by encoding the two extrapolated hand landmarks of the spatio-temporal convergence; and recognizing, by the electronic device, the at least one hand gesture, based on a sequence of hand pose information.

According to aspects of the disclosure, there is an electronic device, including: a memory storing at least one instruction; and, at least one processor configured to execute the at least one instruction stored in the memory; wherein the at least one processor is configured to execute the at least one instruction to: track a visible trajectory of a hand of the user from a plurality of frames captured by the electronic device, wherein the plurality of frames include a first frame, a second frame, one or more frames captured before the first frame, and one or more frames captured after the second frame; identify the first frame where the hand of the user has gone out of a Field of View (FOV) of the electronic device, among the plurality of frames; identify the second frame where the hand of the user has come back into the FOV of the electronic device, among the plurality of frames; obtain, using an Artificial Intelligence (AI) model, a trajectory of the hand of the user using the one or more frames captured before the first frame among the plurality of frames, and the one or more frames captured after the second frame among the plurality of frames; and recognize at least one hand gesture performed during the visible trajectory of the hand of the user, and the obtained trajectory of the hand of the user.

The at least one processor is configured to execute the at least one instruction to: select a frame, among the plurality of frames, with the presence of the hand of the user from the visible trajectory; and generate references of one or more hand landmarks from the frame with the presence of the hand of the user.

The at least one processor is configured to execute the at least one instruction to: estimate a location of the one or more hand landmarks of the one or more frames captured before the first frame, based on the generated references of the one or more hand landmarks; calculate one or more kinetic parameters of each hand landmark, using the estimated location of the one or more hand landmarks of consecutive frames, wherein the consecutive frames includes the one or more frames captured before the first frame; and obtain a first trajectory of the hand of the user using the one or more frames captured before the first frame, using the calculated one or more kinetic parameters of each of the one or more hand landmarks.

The at least one processor is configured to execute the at least one instruction to: reverse the order of the plurality of frames captured by the electronic device; estimate a location of the one or more hand landmarks of the one or more frames captured after the second frame, based on the generated references of the one or more hand landmarks; calculate one or more kinetic parameters of each hand landmark, using the estimated location of the one or more hand landmarks of consecutive frames, wherein the consecutive frames includes the one or more frames captured after the second frame; and obtain a second trajectory of the hand of the user corresponding to the one or more frames captured after the second frame, using the calculated one or more kinetic parameters of each of the one or more hand landmarks.

The one or more kinetic parameters of the hand of the user may include at least one of a velocity, and an acceleration of each of the one or more hand landmarks.

The at least one processor is configured to execute the at least one instruction to: verify if the hand of the user is in the FOV of the electronic device, after calculating one or more kinetic parameters of each of the one or more hand landmarks; and calculate a velocity and a position of the one or more hand landmarks in a next frame, of the plurality of frames and after the one or more frames captured after the second frame, using the calculated one or more kinetic parameters of each of the one or more hand landmarks, if the hand of the user is not in the FOV of the electronic device.

The at least one processor is configured to execute the at least one instruction to: verify at least one parameter of the hand of the user, after calculating the velocity and the position of the one or more hand landmarks in the next frame, wherein the at least one parameter includes at least one of whether a velocity goes to zero, a hand position is beyond a threshold, and the one or more hand landmarks no longer conform to predetermined bio-mechanical constraints of a human hand; repeat a verification of the hand of the user in the FOV of the electronic device, if the at least one parameter of the hand of the user is not satisfied; and repeat estimation of the location of the one or more hand landmarks from a previous frame, previous to the next frame, if the hand of the user is stationary and the at least one parameter of the hand of the user is satisfied.

The processor may be further configured to: check closeness of the one or more hand landmarks for each frame, of the plurality of frames, from the first trajectory and the second trajectory of the hand of the user; obtain a spatio-temporal convergence at a frame, of the plurality of frames, where a distance between two extrapolated hand landmarks is below a certain threshold, wherein a trajectory until the frame of the spatio-temporal convergence is considered as the first trajectory, wherein a trajectory after the frame of the spatio-temporal convergence is considered as the second trajectory; estimate a hand pose by encoding the two extrapolated hand landmarks of the spatio-temporal convergence; and recognize the at least one hand gesture, based on a sequence of hand pose information.

According to an aspect of the disclosure, there is a method for predicting a hand gesture in a multi-camera device, the method including: predicting, by the multi-camera device, an outward trajectory for one or more frames where the hand of the user goes out of a Field of view (FOV) of the multi-camera device; predicting, by the multi-camera device, an inward trajectory from one or more frames where the hand of the user comes back into the FOV of the multi-camera device, wherein the inward trajectory is predicted by reversing the order of the one or more frames where the hand of the user comes back into the FOV; estimating, by the multi-camera device, a convergence point of the outward trajectory and the inward trajectory in temporal and spatial domains; and recognizing, by the multi-camera device, at least one hand gesture, based on a sequence of hand pose information obtained from the estimated convergence point, wherein a hand pose is estimated by encoding one or more extrapolated hand landmarks of the convergence point.

According to an aspect of the disclosure, there is a multi-camera device, including: a memory, and at least one processor configured to execute the at least one instruction stored in the memory, wherein the at least one processor is configured to execute the at least one instruction to: obtain an outward trajectory for one or more frames where the hand of the user goes out of a Field of view (FOV) of the multi-camera device; obtain an inward trajectory from one or more frames where the hand of the user comes back into the FOV of the multi-camera device, wherein the inward trajectory is predicted by reversing the order of the one or more frames where the hand of the user comes back into the FOV; estimate a convergence point of the outward trajectory and the inward trajectory in temporal and spatial domains; and recognize at least one hand gesture, based on a sequence of hand pose information obtained from the estimated convergence point, wherein a hand pose is estimated by encoding one or more extrapolated hand landmarks of the convergence point.

The at least one processor is configured to execute the at least one instruction to control an action to at least one of a video game and a user interface window depending on recognizing the hat least one hand gesture.

According to an aspect of the disclosure, the electronic device and methods disclose performing out of field of view hand tracking using spatio-temporal outward and inward convergence.

According to an aspect of the disclosure, the electronic device and methods disclose encoding hand trajectory information even when the hands are out of view of the camera, based on trajectories from one or more previous and next frames.

According to an aspect of the disclosure, the electronic device and methods disclose tracking acceleration and direction of motion of the hand from the visible frames to predict a convergence point in space and time.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 depicts an existing hand tracking method, according to prior arts;

FIG. 2 depicts an example scenario of a Head Mounted Display (HMD) with a multi-camera array and Field of View (FOVs) of cameras, according to prior arts;

FIG. 3 depicts a block representation of an electronic device for performing gesture recognition in the electronic device, according to embodiments as disclosed herein;

FIG. 4 depicts a method for performing gesture recognition in the electronic device, according to embodiments as disclosed herein;

FIG. 5 depicts a method for estimating spatio-temporal convergence for performing gesture recognition in the electronic device, according to embodiments as disclosed herein;

FIG. 6 depicts a comparison between an existing hand gesture recognition method and disclosed hand gesture recognition method, according to embodiments as disclosed herein;

FIG. 7 depicts a method for predicting a trajectory of the out of FOV hand, according to embodiments as disclosed herein;

FIG. 8 depicts a flow process for performing hand gesture recognition, according to embodiments as disclosed herein;

FIG. 9A depicts example flow processes to extrapolate the trajectory of the hand that was not in the FOV and predict spatio-temporal convergence for gesture recognition, according to embodiments as disclosed herein;

FIG. 9B depicts example flow processes to extrapolate the trajectory of the hand that was not in the FOV and predict spatio-temporal convergence for gesture recognition, according to embodiments as disclosed herein;

FIG. 10 depicts an example use case, where the user performs a left swipe gesture, according to embodiments as disclosed herein;

FIG. 11 depicts an example use case, where the user grabs a VR object and moving the hand from one camera FOV to another, according to embodiments as disclosed herein; and

FIG. 12 depicts an example use case, where the user plays a VR game, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

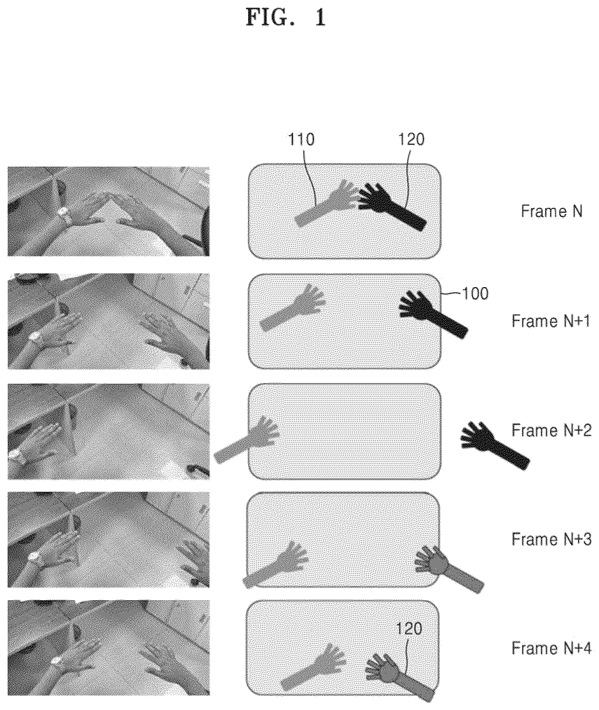

FIG. 1 depicts an existing hand tracking method, according to prior arts.

FIG. 1 shows an existing hand tracking method. Initially, two hands are detected shown in grey hand (110) and black hand (120) in a Field of View (FOV, 100) of an electronic device such as Head mounted display (HMD). When the black hand (120) goes out of field of view (100) and comes back, as there is no accurate tracking, this is viewed as a new hand (130) as shown in Frame N+3 and Frame N+4. With the existing hand tracking methods, it may be difficult to track hands when they go out of field of view (100). A major problem with the existing hand tracking methods is that the gesture recognition becomes harder when the intermediate frames do not contain a hand in them. This leads to inaccurate gesture detections as well as failing to detect any gesture altogether. For example, a hand wave gesture can be mis-classified as a swipe right gesture. Detecting gestures is a very important feature to receive user feedback and for the user to interact with a User Interface (UI) of the device. Also, for devices such as HMDs, it may not be possible to always keep the hands in the field of view (100) of the camera. Thus, there is a need to accurately track the hands that go out of field of view (100).

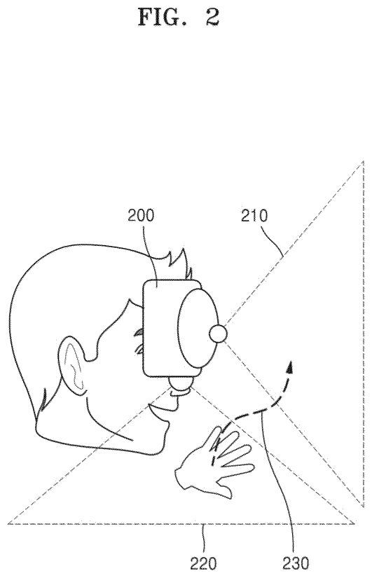

FIG. 2 depicts an example scenario of a Head Mounted Display (HMD, 200) with a multi-camera array and Field of View (FOVs) of cameras, according to prior arts.

In case of HMD 200, there may be a multi-camera array and FOVs of these cameras might not overlap, as depicted in example scenario in FIG. 2. Also in some cases, there might be blind spots even if there are overlaps. As shown in FIG. 2, FOV of front facing cameras 210 and FOV of downward facing cameras 220 might not have any overlap. While performing hand gestures in a HMD 200 use-case, an understanding of hand movements is required, even when the hands are out of FOV. Hand trajectory 230 is as shown using an arrow.

Hence, there is a need in the art for solutions which will overcome the above mentioned drawbacks, among others.

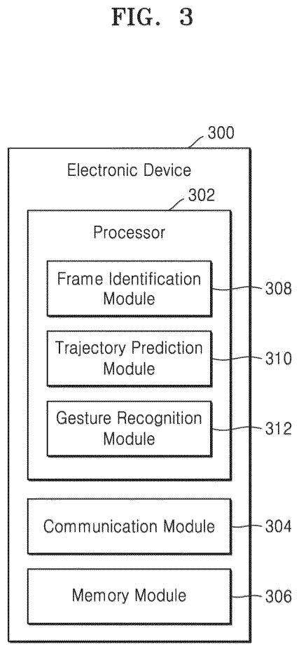

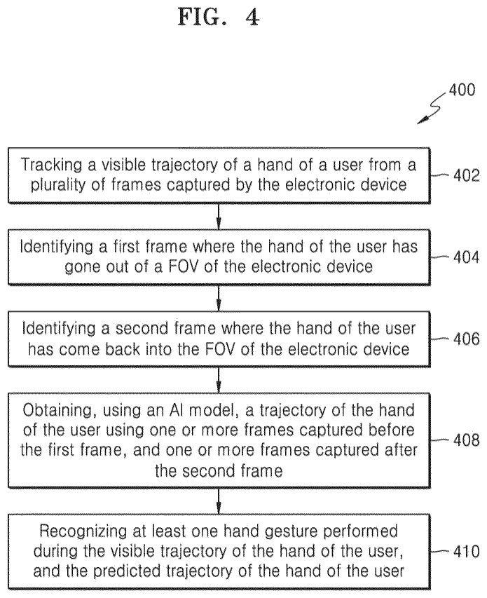

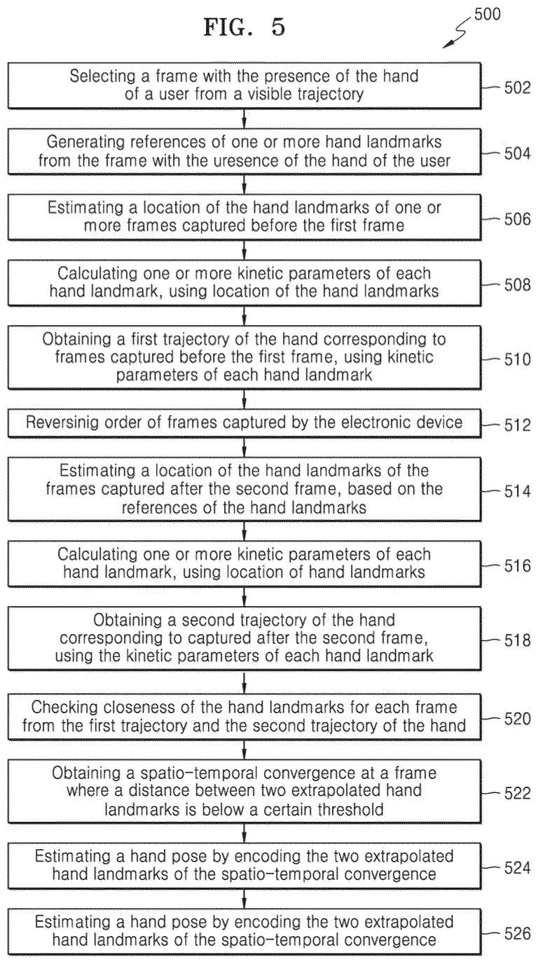

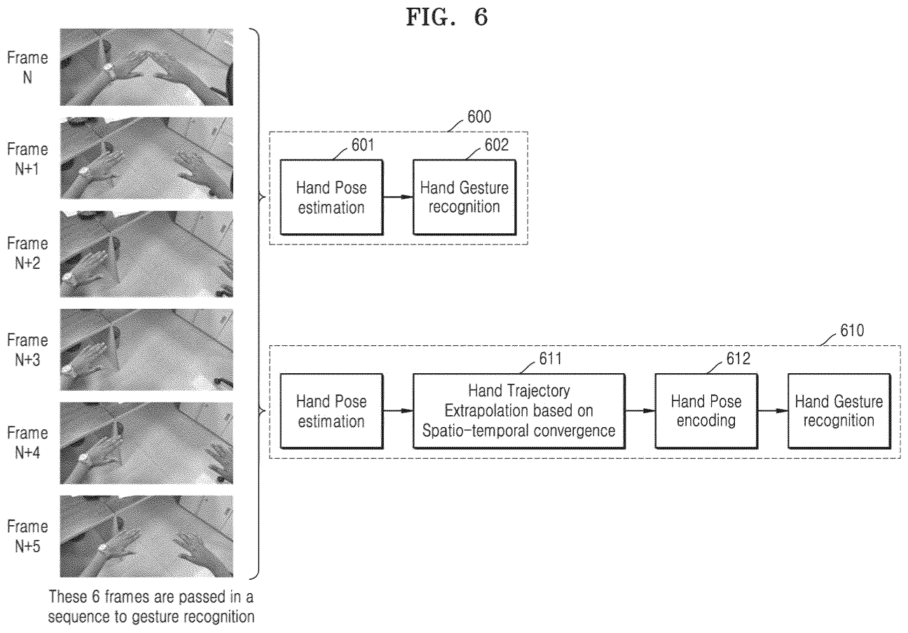

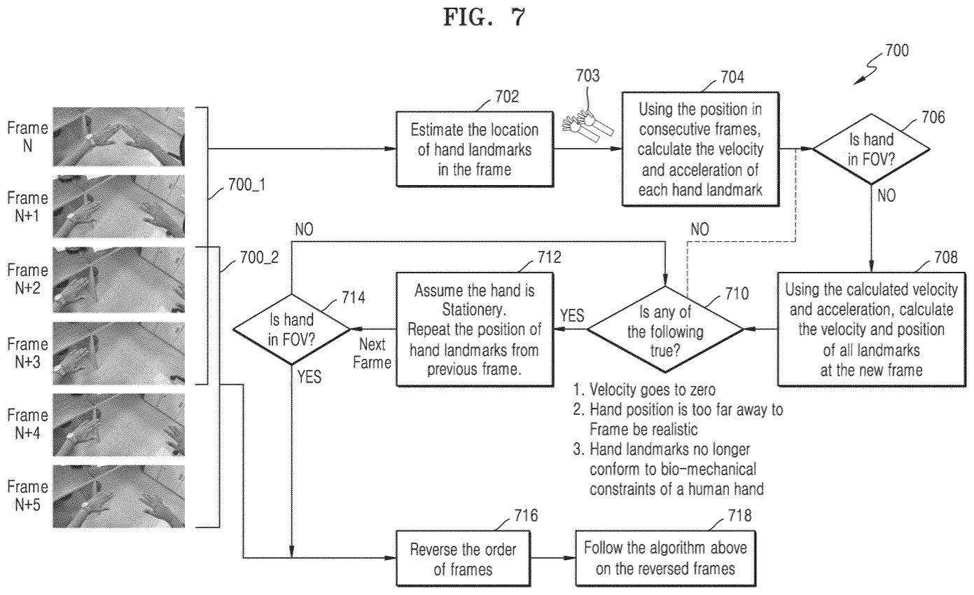

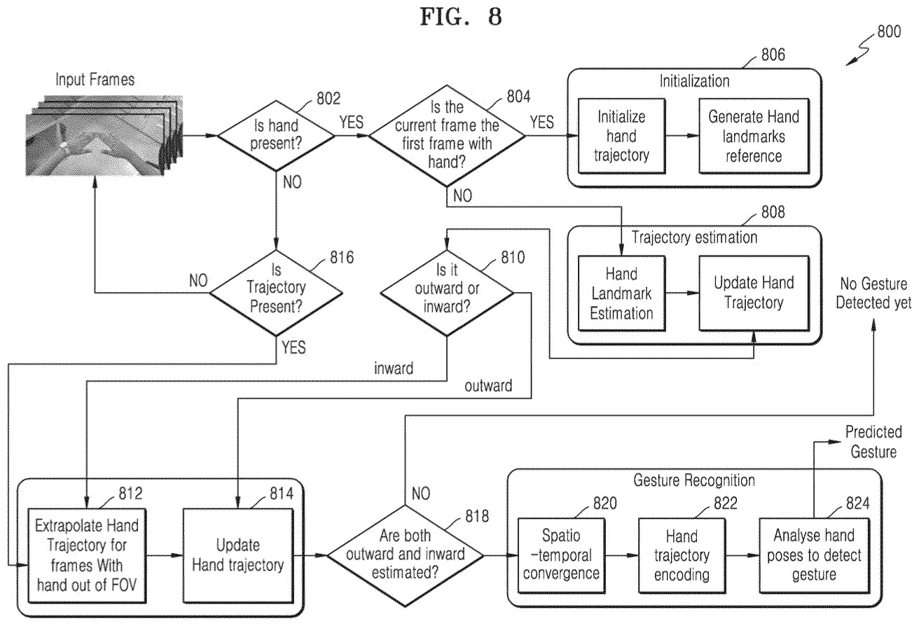

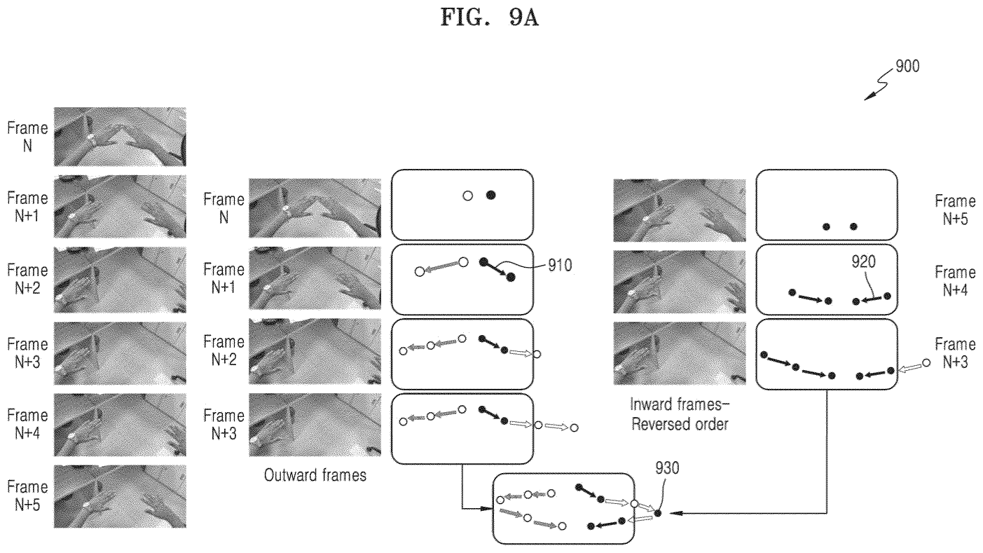

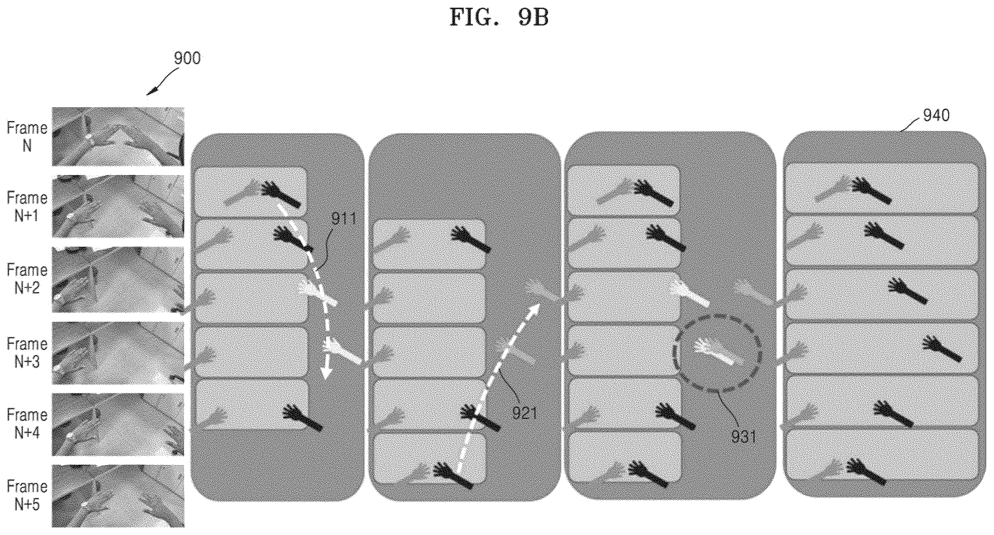

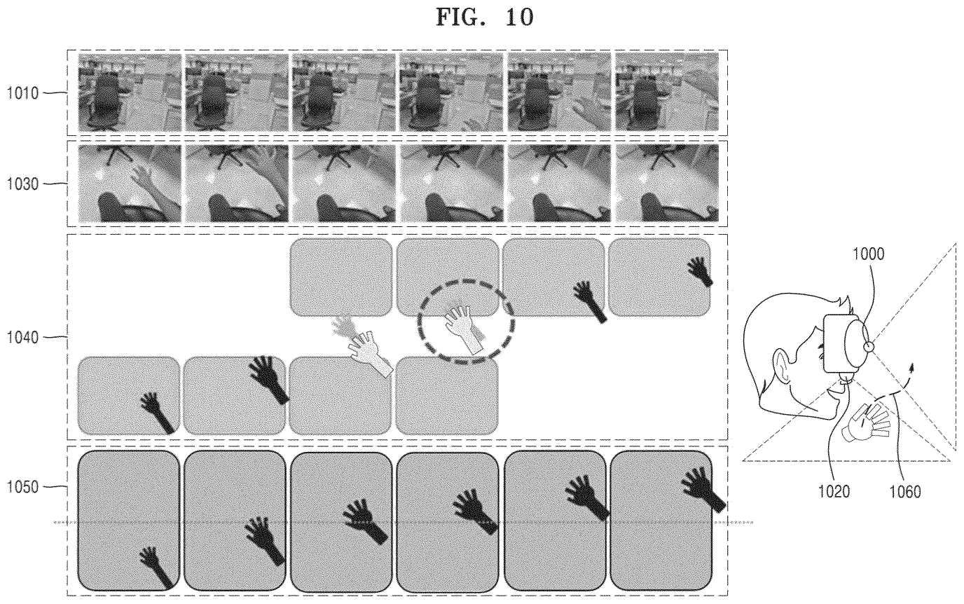

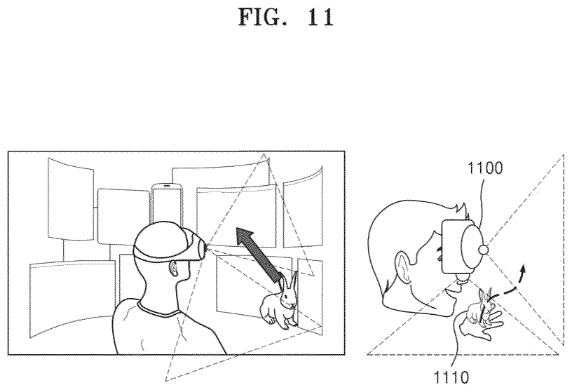

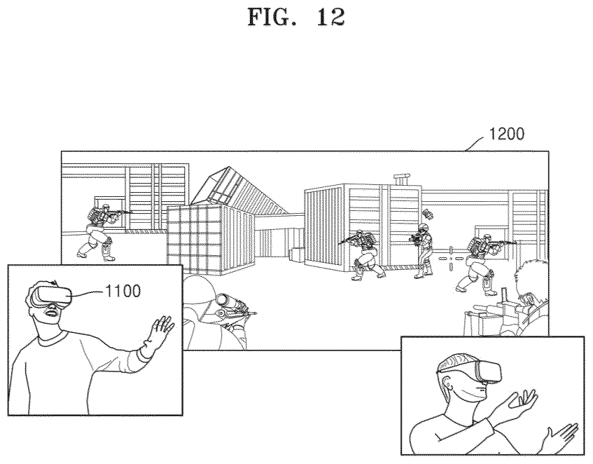

The embodiments herein disclose electronic device and methods for predicting trajectory of a user's hand even when the hand is out of view of the camera. Referring now to the drawings, and more particularly to FIG. 3, FIG. 4, FIG. 5, FIG. 6, FIG. 7, FIG. 8, FIG. 9A, FIG. 9B, FIG. 10, FIG. 11, and FIG. 12, where similar reference characters denote corresponding features consistently throughout the figures, there are shown embodiments.

FIG. 3 depicts a block representation of an electronic device for performing gesture recognition in the electronic device 300, according to embodiments as disclosed herein. FIG. 3 shows the electronic device 300 (for example, a multi-camera device, and a (Visual See-Through (VST) device). The electronic device 300 comprises a processor 302, a communication module 304, and a memory module 306. The processor 302 further comprises a frame identification module 308, a trajectory prediction module 310, and a gesture recognition 312.

In an embodiment herein, instructions, a data structure, and a program code, which are readable by the processor 302, may be stored in the memory 306. In an embodiment herein, operations that are performed by the processor 302 may be implemented by executing instructions or codes of a program stored in the memory 306. Instructions, an algorithm, a data structure, a program code, and an application program stored in the memory 306 may be implemented with a programming or scripting language, such as, for example, C, C++, Java, and assembler.

In an embodiment herein, a frame identification module 308, a trajectory prediction module 310, and a gesture recognition module 312 may be stored in the memory 306. In an embodiment herein, a ‘module’ included in the memory 306 may mean a unit for processing a function or operation that is performed by the at least one processor 302. The ‘module’ included in the memory 306 may be embodied as software, such as instructions, an algorithm, a data structure, or a program code.

In an embodiment herein, the at least one processor 302 may execute an instruction, program code, or algorithm of the frame identification module 308 to track a visible trajectory of a hand of a user from a plurality of frames captured by the electronic device 300. The at least one processor 302 may execute an instruction, program code, or algorithm of the frame identification module 308 to identify a first frame where the hand of the user has gone out of a Field of View (FOV) of the electronic device 300. The at least one processor 302 may execute an instruction, program code, or algorithm of the frame identification module 308 to identify a second frame where the hand of the user has come back into the FOV of the electronic device 300.

In an embodiment herein, the at least one processor 302 may execute an instruction, program code, or algorithm of the trajectory prediction module 310 to obtain a trajectory of the hand of the user using one or more frames captured before the first frame, and one or more frames captured after the second frame. The at least one processor 302 may execute an instruction, program code, or algorithm of the trajectory prediction module 310 to obtain the trajectory of the hand of the user using the Artificial Intelligence (AI) model. In an embodiment herein, the AI model may be an AI model trained to predict the trajectory of the hand of the user using one or more frames captured before the first frame, and one or more frames captured after the second frame. In an embodiment herein, the AI model included in the trajectory prediction model 310 may include a machine learning model or a deep learning model. The AI model may be an AI model trained to predict the trajectory based on a training dataset labeled with a trajectory and a captured frame image.

In an embodiment herein, the at least one processor 302 may execute an instruction, program code, or algorithm of the trajectory prediction module 310 to select a frame with the presence of the hand of the user from the visible trajectory. The at least one processor 302 may execute an instruction, program code, or algorithm of the trajectory prediction module 310 to generate references of one or more hand landmarks from the frame with the presence of the hand of the user. The at least one processor 302 may execute an instruction, program code, or algorithm of the trajectory prediction module 310 to estimate a location of the hand landmarks of the frames captured before the first frame, based on the generated references of the hand landmarks. The at least one processor 302 may execute an instruction, program code, or algorithm of the trajectory prediction module 310 to calculate one or more kinetic parameters of each hand landmark, using the estimated location of the hand landmarks of consecutive frames. The kinetic parameters of the hand of the user can include, but not necessarily limited to, a velocity, and an acceleration of each hand landmark. The at least one processor 302 may execute an instruction, program code, or algorithm of the trajectory prediction module 310 to obtain a first trajectory of the hand of the user corresponding to the frames captured before the first frame, using the calculated kinetic parameters of each hand landmark. The hand landmarks could be any of parts of a hand, creases, shapes, relative distances between digits, inter-digit distances, markings, bruising, relative discoloration, tattoos, scars, hair, nails, etc.

In an embodiment herein, the at least one processor 302 may execute an instruction, program code, or algorithm of the trajectory prediction module 310 to reverse order of the frames captured by the electronic device 300. The at least one processor 302 may execute an instruction, program code, or algorithm of the trajectory prediction module 310 to estimate a location of the hand landmarks of the frames captured after the second frame, based on the generated references of the hand landmarks. The at least one processor 302 may execute an instruction, program code, or algorithm of the trajectory prediction module 310 to calculate one or more kinetic parameters of each hand landmark, using the estimated location of the hand landmarks of consecutive frames. The at least one processor 302 may execute an instruction, program code, or algorithm of the trajectory prediction module 310 can obtain a second trajectory of the hand of the user corresponding to the frames captured after the second frame, using the calculated kinetic parameters of each hand landmark.

In an embodiment herein, The at least one processor 302 may execute an instruction, program code, or algorithm of the trajectory prediction module 310 to verify if the hand of the user is in the FOV of the electronic device 300, after calculating one or more kinetic parameters of each hand landmark. The at least one processor 302 may execute an instruction, program code, or algorithm of the trajectory prediction module 310 to calculate a velocity and a position of the hand landmarks in a next frame using the calculated kinetic parameters of each hand landmark, if the hand of the user is not in the FOV of the electronic device 300.

In an embodiment herein, The at least one processor 302 may execute an instruction, program code, or algorithm of the trajectory prediction module 310 to verify at least one parameter of the hand of the user, after calculating the velocity and the position of the hand landmarks in the next frame. The parameter can be, but not necessarily limited to, whether a velocity goes to zero, a hand position is far away to be realistic, the hand landmarks no longer conform to bio-mechanical constraints of a human hand, and so on. The at least one processor 302 may execute an instruction, program code, or algorithm of the trajectory prediction module 310 to repeat a verification of the hand of the user in the FOV of the electronic device 300, if the parameter of the hand of the user is not satisfied. The at least one processor 302 may execute an instruction, program code, or algorithm of the trajectory prediction module 310 to repeat estimation of the location of the hand landmarks from a previous frame, if the hand of the user is stationary and the parameter of the hand of the user is satisfied.

In an embodiment herein, The at least one processor 302 may execute an instruction, program code, or algorithm of the gesture recognition module 312 to recognize at least one hand gesture performed during the visible trajectory of the hand of the user, and the predicted trajectory of the hand of the user.

In an embodiment herein, The at least one processor 302 may execute an instruction, program code, or algorithm of the gesture recognition module 312 to check closeness of the hand landmarks for each frame from the first trajectory and the second trajectory of the hand of the user. The at least one processor 302 may execute an instruction, program code, or algorithm of the gesture recognition module 312 to obtain a spatio-temporal convergence at a frame where a distance between two extrapolated hand landmarks is below a certain threshold. A trajectory until the frame of the spatio-temporal convergence is considered as the first trajectory (outward trajectory). The outward trajectory is predicted for one or more frames where the hand of the user goes out of the FOV of the electronic device 300. A trajectory after the frame of the spatio-temporal convergence is considered as the second trajectory (inward trajectory). The inward trajectory is predicted from one or more frames where the hand of the user comes back into the FOV of the electronic device 300. The inward trajectory is predicted by reversing the order of the frames where the hand of the user comes back into the FOV. A convergence point of the outward trajectory and the inward trajectory is estimated in temporal and spatial domains. The at least one processor 302 may execute an instruction, program code, or algorithm of the gesture recognition module 312 to estimate a hand pose by encoding the two extrapolated hand landmarks of the spatio-temporal convergence or the convergence point. The at least one processor 302 may execute an instruction, program code, or algorithm of the gesture recognition module 312 to recognize the hand gesture, based on a sequence of hand pose information obtained from the estimated convergence point.

In an embodiment herein, the processor 302 can process and execute data of a plurality of modules of the electronic device 300. The processor 302 can be configured to execute instructions stored in the memory module 306. The processor 302 may comprise one or more of microprocessors, circuits, and other hardware configured for processing. The processor 302 can be at least one of a single processer, a plurality of processors, multiple homogeneous or heterogeneous cores, multiple Central Processing Units (CPUs) of different kinds, microcontrollers, special media, and other accelerators. The processor 302 may be an application processor (AP), a graphics-only processing unit (such as a graphics processing unit (GPU), a visual processing unit (VPU)), and/or an Artificial Intelligence (AI)-dedicated processor (such as a neural processing unit (NPU)).

According to an embodiment of the disclosure, the at least one processor 302 may include a circuitry such as a system on chip (SoC) or an integrated circuit (IC).

In an embodiment herein, the plurality of modules of the processor 302 of the electronic device 300 can communicate via the communication module 304. The communication module 304 may be in the form of either a wired network or a wireless communication network module. The wireless communication network may comprise, but not necessarily limited to, Global Positioning System (GPS), Global System for Mobile Communications (GSM), Wi-Fi, Bluetooth low energy, Near-field communication (NFC), and so on. The wireless communication may further comprise one or more of Bluetooth, ZigBee, a short-range wireless communication (such as Ultra-Wideband (UWB)), and a medium-range wireless communication (such as Wi-Fi) or a long-range wireless communication (such as 3G/4G/5G/6G and non-3GPP technologies or WiMAX), according to the usage environment.

In an embodiment herein, the memory module 306 may comprise one or more volatile and non-volatile memory components which are capable of storing data and instructions of the modules of the electronic device 300 to be executed. Examples of the memory module 306 can be, but not necessarily limited to, NAND, embedded Multi Media Card (eMMC), Secure Digital (SD) cards, Universal Serial Bus (USB), Serial Advanced Technology Attachment (SATA), solid-state drive (SSD), and so on. The memory module 306 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory module 306 may, in some examples, be considered a non-transitory storage medium. The term “non-transitory” may indicate that the storage medium is not embodied in a carrier wave or a propagated signal. However, the term “non-transitory” should not be interpreted to mean that the memory module 306 is non-movable. In certain examples, a non-transitory storage medium may store data that can, over time, change (for example, in Random Access Memory (RAM) or cache).

FIG. 3 shows example modules of the electronic device 300, but it is to be understood that other embodiments are not limited thereon. In other embodiments, the electronic device 300 may include less or more number of modules. Further, the labels or names of the modules are used only for illustrative purpose and does not limit the scope of the invention. One or more modules can be combined together to perform same or substantially similar function in the electronic device 300.

FIG. 4 depicts a method for performing gesture recognition in an electronic device, according to embodiments as disclosed herein. FIG. 4 shows the method 400 comprising various steps for performing gesture recognition in the electronic device 300. The method 400 comprises tracking, by the processor 302 of the electronic device 300, a visible trajectory of a hand of a user from a plurality of frames captured by the electronic device 300, as depicted in step 402. The method 400 comprises identifying, by the processor 302, a first frame where the hand of the user has gone out of a FOV of the electronic device 300, as depicted in step 404.

Thereafter, the method 400 comprises identifying, by the processor 302, a second frame where the hand of the user has come back into the FOV of the electronic device 300, as depicted in step 406. The method 400 comprises predicting, by the processor 302, using an AI model, a trajectory of the hand of the user using one or more frames captured before the first frame, and one or more frames captured after the second frame, as depicted in step 408. The method 400 comprises recognizing, by the processor 302, at least one hand gesture performed during the visible trajectory of the hand of the user, and the predicted trajectory of the hand of the user, as depicted in step 410.

The various actions in method 400 may be performed in the order presented, in a different order or simultaneously. Further, in some embodiments, some actions listed in FIG. 4 may be omitted.

FIG. 5 depicts a method 500 for estimating spatio-temporal convergence for performing gesture recognition in an electronic device, according to embodiments as disclosed herein. FIG. 5 shows the method 500 comprising various steps for estimating spatio-temporal convergence for performing gesture recognition in the electronic device 300. The method 500 comprises selecting, by the processor 302 of the electronic device 300, a frame with the presence of the hand of the user from the visible trajectory, as depicted in step 502. The method 500 comprises generating, by the processor 302, references of one or more hand landmarks from the frame with the presence of the hand of the user, as depicted in step 504. The method 500 comprises estimating, by the processor 302, a location of the hand landmarks of one or more frames captured before the first frame, based on the generated references of the hand landmarks, as depicted in step 506.

Thereafter, the method 500 comprises calculating, by the processor 302, one or more kinetic parameters of each hand landmark, using the estimated location of the hand landmarks of consecutive frames, as depicted in step 508. The method 500 comprises obtaining, by the processor 302, a first trajectory of the hand of the user corresponding to the frames captured before the first frame, using the calculated kinetic parameters of each hand landmark, as depicted in step 510.

Later, the method 500 comprises reversing, by the processor 302, order of the frames captured by the electronic device 300, as depicted in step 512. The method 500 comprises estimating, by the processor 302, a location of the hand landmarks of the frames captured after the second frame, based on the generated references of the hand landmarks, as depicted in step 514. The method 500 comprises calculating, by the processor 302, one or more kinetic parameters of each hand landmark, using the estimated location of the hand landmarks of consecutive frames, as depicted in step 516. The method 500 comprises obtaining, by the processor 302, a second trajectory of the hand of the user corresponding to the frames captured after the second frame, using the calculated kinetic parameters of each hand landmark, as depicted in step 518.

The method 500 comprises checking, by the processor 302, closeness of the hand landmarks for each frame from the first trajectory and the second trajectory of the hand of the user, as depicted in step 520. The method 500 comprises obtaining, by the processor 302, a spatio-temporal convergence at a frame where a distance between two extrapolated hand landmarks is below a certain threshold, as depicted in step 522. A trajectory until the frame of the spatio-temporal convergence is considered as the first trajectory (outward trajectory). A trajectory after the frame of the spatio-temporal convergence is considered as the second trajectory (inward trajectory).

Thereafter, the method 500 comprises estimating, by the processor 302, a hand pose by encoding the two extrapolated hand landmarks of the spatio-temporal convergence, as depicted in step 524. The method 500 comprises recognizing, by the processor 302, the hand gesture, based on a sequence of hand pose information, as depicted in step 526.

The various actions in method 500 may be performed in the order presented, in a different order or simultaneously. Further, in some embodiments, some actions listed in FIG. 5 may be omitted.

FIG. 6 depicts a comparison between an existing hand gesture recognition method and disclosed hand gesture recognition method according to embodiments according to embodiments as disclosed herein. FIG. 6 shows the existing hand gesture recognition method 600 and the disclosed hand gesture recognition method 610. In existing hand gesture recognition method 600, estimation of the hand pose 601 does not provide any output when no hand is present in the FOV and recognition of hand gesture 602 is not accurate if one or more frames in the sequence do not have hand pose information. When the hand is not present in certain frames in the sequence, the disclosed hand gesture recognition method according to embodiments can encode hand pose 612 this information based on the hand trajectory 611 from before after these frames.

FIG. 7 depicts a method for predicting a trajectory of the out of FOV hand, according to embodiments as disclosed herein. FIG. 7 shows the method 700 for predicting the trajectory of the out of FOV hand. The method 700 comprises receiving a sequence of outward frames 700_1 and inward frames 700_2, and calculating the kinetic parameters (such as, but not necessarily limited to, velocity and acceleration of the hand), before the hand goes out of view in outward frames 700_1. Embodiments herein extrapolate the trajectory using the kinetics to estimate the position and velocity of the hand when the hand is not in view. Using the extrapolated trajectory of the hand in both outward frames 700_1 and inward frames 700_2, embodiments herein detect the convergence in space and time. Using the outward trajectory till the convergence and the inward trajectory after the convergence, embodiments herein can predict the complete trajectory when the hand is out of the FOV.

As depicted, for the frames where the hand goes outward (out of FOV), location of hand landmarks 703 in the frame is estimated, as depicted in step 702. Using the position in consecutive frames, the velocity and acceleration of each hand landmark 703 is calculated, as depicted in step 704. Later, a verification is done to check if the hand of the user is in the FOV of the electronic device 300, after calculating the kinetic parameters (velocity and acceleration) of each hand landmark, as depicted in step 706.

Using the calculated velocity and acceleration, a velocity and a position of one or more hand landmarks 703 in a next frame are calculated, as depicted in step 708, if the hand of the user is not in the FOV of the electronic device 300. If the hand of the user is in the FOV, then estimation of location of hand landmarks in the frame is repeated, as depicted in step 702. Later, at least one parameter of the hand of the user is verified, after calculating the velocity and the position of one or more hand landmarks in the next frame, as depicted in step 710. The parameter can include, but not necessarily limited to, whether a velocity goes to zero, a hand position is beyond the threshold, hand landmarks no longer conform to predetermined bio-mechanical constraints of a human hand, and so on. The threshold may be set based on the physically possible distance between the electronic device 300 and the hand. The predetermined bio-mechanical constraints of the human hand may be set by the structure of the human body as limits to where the hand can be positioned.

If at least one parameter of the hand of the user is not satisfied, then verification of the hand of the user in the FOV of the electronic device 300 is repeated, as depicted in step 706. If at least one parameter of the hand of the user is satisfied, then the hand of the user is assumed to be stationary and estimation of location of one or more hand landmarks from a previous frame is repeated, as depicted in step 712.

For the frames, where the hand comes inward (back into FOV), a verification is done to check if hand of the user is in the FOV, as depicted in step 714. The order of frames is reversed, if hand of the user is in the FOV, as depicted in step 716. If hand of the user is not in the FOV, then at least one parameter of the hand of the user is verified, as depicted in step 710. Later, the above steps (702, 704, 706, 708, 710, 712 and 714) performed for the frames where the hand goes outward is followed on the reversed frames, as depicted in step 718.

The various actions in method 700 may be performed in the order presented, in a different order or simultaneously. Further, in some embodiments, some actions listed in FIG. 7 may be omitted.

FIG. 8 depicts a flow process 800 for performing hand gesture recognition, according to embodiments as disclosed herein. FIG. 8 shows the flow process 800 for performing hand gesture recognition. For the received input frames, verification is done to check if hand is present in the FOV, as depicted in step 802. If the hand is present in the FOV, then verification is done to check if the current frame is the first frame with hand, as depicted in step 804. If the current frame is the first frame with hand, then hand trajectory is initialized and hand landmarks references are generated, as depicted in step 806. If the current frame is not the first frame with hand, then hand landmark is estimated and hand trajectory is updated, as depicted in step 808.

Later, verification is done to check if the hand is outward or inward in the updated hand trajectory, as depicted in step 810. If the hand is inward, then the hand trajectory for frames with hand out of FOV is extrapolated, as depicted in step 812. If the hand is outward, the hand trajectory is updated, as depicted in step 814.

If the hand is not present in the FOV, as verified in step 802, then verification is done to check if trajectory is present, as depicted in step 816. If trajectory is not present, then input frames are received to check if hand is present, as depicted in step 802. If trajectory is present, then the hand trajectory for frames with hand out of FOV is extrapolated, as depicted in step 812.

After updating hand trajectory as depicted in step 814, verification is done to check whether both outward and inward trajectories are estimated, as depicted in step 818. If both outward and inward trajectories are not estimated, then no gesture is detected. If both outward and inward trajectories are estimated, then spatio-temporal convergence is estimated, as depicted in step 820. Later, hand trajectory is encoded, as depicted in step 822. Hand poses are analyzed based on the encoded hand trajectory, as depicted in step 824. From the hand poses and the spatio-temporal convergence, hand gesture is predicted.

The various actions in method 800 may be performed in the order presented, in a different order or simultaneously. Further, in some embodiments, some actions listed in FIG. 8 may be omitted.

FIG. 9A depicts example flow processes to extrapolate the trajectory of the hand that was not in the FOV and predict spatio-temporal convergence for gesture recognition, according to embodiments as disclosed herein. FIG. 9B depicts example flow processes to extrapolate the trajectory of the hand that was not in the FOV and predict spatio-temporal convergence for gesture recognition. In this scenario, six frames 900 are considered and the hand goes out of sight for two of those frames. Consider the trajectory of the hand before the hand goes out of FOV (outward trajectory 910, 911) and after the hand comes back into FOV (inward trajectory 920, 921). Frames N to N+3 show the hand before it goes out of FOV. The outward trajectory 910, 911 is shown in black and the extrapolated trajectory is shown in grey. Frames N+5 to N+3 gives the hand after it comes in FOV. The inward trajectory 920, 921 is shown in dark grey and the extrapolated trajectory is shown in light grey.

The order of frames after the hand comes into the FOV is reversed to extrapolate the hand trajectory before coming in. Later, convergence 930, 931 of the outward trajectory 910, 911 and inward trajectory 920, 921 is obtained in both temporal (frame) and spatial (location) domains.

For example, once both the outward trajectory 910, 911 and inward trajectory 920, 921 of the hand landmarks are obtained, for each frame, closeness of the hand landmarks from both the trajectories is checked. On getting a frame where the distance between the two extrapolated hand landmarks are below a certain threshold, this is considered as the spatio-temporal convergence 930, 931. Until this frame, the outward trajectory 910, 911 is considered, and after this frame, the inward trajectory 920, 921 is considered. Using this information, the hand landmarks are encoded to be processed for gesture recognition 940. Gesture recognition can be done on sequence of hand pose information encoded 940 in the previous step.

FIG. 10 depicts an example use case, where the user performs a left swipe gesture according to embodiments as disclosed herein. For frames 1010 captured with a top left camera 1000 and frames 1030 captured with a bottom left camera 1020, spatio-temporal convergence 1050 is estimated. The spatio-temporal convergence 1050 is estimated based on hand trajectory extrapolation for missing inward frames, and hand trajectory extrapolation for missing outward frames. Thereafter, hand gesture 1060 is predicted for the left swipe, based on hand trajectory encoding 1050.

FIG. 11 depicts an example use case, where the user grabs a VR object and moving the hand from one camera FOV to another, according to embodiments as disclosed herein. FIG. 12 depicts an example use case, where the user plays a VR game according to embodiments as disclosed herein.

If the hand is not tracked properly, the VR object may not be rendered in the second view. The disclosed methods can accurately track the hand and render the VR object in the second view as well. In intense action games on the Head Mounted Displays (HMD), hands go out of FOV of cameras and come back frequently.

As such, embodiments herein are used to control the activities displayed to the user, such as in the game or office/analysis environment of FIG. 11. and FIG. 12. For example, assuming that a hand of the user, tracked in such environment, goes out of frame and then back into a frame, and is determined as such according to embodiments herein, then any determined gesture with respect to even that going out of and then back into frame is used to control, or to continue a control, in such environments. For example, to make an action in the game shown in FIG. 12, such as moving an item or object in the game environment, or similarly, in FIG. 11, to make an action such as moving a window or otherwise interacting with any of the user interfaces illustrated in that environment.

Therefore, the hand gesture recognition can be accurately done even when the hands go out of field of view, using the disclosed methods. The hand gesture recognition can be accurately performed even in the scenario when the hand moves from one camera FOV to the other in a multi-camera device. The hand trajectory information can be encoded (even when the hands are not visible) based on the trajectories from previous and next frames.

The embodiments disclosed herein can be implemented through at least one software program running on at least one hardware device. The modules shown in FIG. 3 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

What is claimed is:

1. A method for performing gesture recognition in an electronic device, comprising:
tracking, by the electronic device, a visible trajectory of a hand of a user from a plurality of frames captured by the electronic device;
identifying, by the electronic device, the first frame, where the hand of the user has gone out of a Field of View (FOV) of the electronic device, among the plurality of frames;
identifying, by the electronic device, the second frame, where the hand of the user has come back into the FOV of the electronic device, among the plurality of frames;
obtaining, by the electronic device, using an Artificial Intelligence (AI) model, a trajectory of the hand of the user using the one or more frames captured before the first frame among the plurality of frames and the one or more frames captured after the second frame among the plurality of frames; and
recognizing, by the electronic device, at least one hand gesture performed during the visible trajectory of the hand of the user, and the obtained trajectory of the hand of the user.

2. The method as claimed in claim 1, further comprising:
selecting, by the electronic device, a frame with the presence of the hand of the user from the visible trajectory, among the plurality of frames; and
generating, by the electronic device, references of one or more hand landmarks from the frame with the presence of the hand of the user.

3. The method as claimed in claim 2, further comprising:
estimating, by the electronic device, a location of the one or more hand landmarks of the one or more frames captured before the first frame, based on the generated references of the one or more hand landmarks;
calculating, by the electronic device, one or more kinetic parameters of each hand landmark, using the estimated location of the one or more hand landmarks of consecutive frames, wherein the consecutive frames comprise the one or more frames captured before the first frame; and
obtaining, by the electronic device, a first trajectory of the hand of the user corresponding to the one or more frames captured before the first frame, using the calculated one or more kinetic parameters of each of the one or more hand landmarks.

4. The method as claimed in claim 2, further comprising:
reversing, by the electronic device, order of the plurality of frames captured by the electronic device;
estimating, by the electronic device, a location of the one or more hand landmarks of the one or more frames captured after the second frame, based on the generated references of the one or more hand landmarks;
calculating, by the electronic device, one or more kinetic parameters of each hand landmark, using the estimated location of the one or more hand landmarks of consecutive frames, wherein the consecutive frames comprise the one or more frames captured after the second frame; and
obtaining, by the electronic device, a second trajectory of the hand of the user using the one or more frames captured after the second frame, using the calculated one or more kinetic parameters of each of the one or more hand landmarks.

5. The method as claimed in claim 4, wherein the one or more kinetic parameters of the hand of the user comprise at least one of a velocity and an acceleration of each of the one or more hand landmarks.

6. The method as claimed in claim 4, wherein the method comprises:
verifying, by the electronic device, if the hand of the user is in the FOV of the electronic device, after calculating one or more kinetic parameters of each of the one or more hand landmarks; and
calculating, by the electronic device, a velocity and a position of the one or more hand landmarks in a next frame, after the one or more frames captured after the second frame, using the calculated one or more kinetic parameters of each of the one or more hand landmarks, if the hand of the user is not in the FOV of the electronic device.

7. The method as claimed in claim 6, further comprising:
verifying, by the electronic device, at least one parameter of the hand of the user, after calculating the velocity and the position of the one or more hand landmarks in the next frame, wherein the at least one parameter comprises at least one of whether a velocity goes to zero, a hand position is beyond a threshold, and the one or more hand landmarks no longer conform to predetermined bio-mechanical constraints of a human hand;
repeating, by the electronic device, a verification of the hand of the user in the FOV of the electronic device, if the at least one parameter of the hand of the user is not satisfied; and
repeating, by the electronic device, estimation of the location of the one or more hand landmarks from a previous frame, previous to the next frame, if the hand of the user is stationary and the at least one parameter of the hand of the user is satisfied.

8. The method as claimed in claim 3, further comprising:
checking, by the electronic device, closeness of the one or more hand landmarks for each frame, of the plurality of frames, from the first trajectory and the second trajectory of the hand of the user;
obtaining, by the electronic device, a spatio-temporal convergence at a frame, of the plurality of frames, where a distance between two extrapolated hand landmarks is below a certain threshold, wherein a trajectory until the frame of the spatio-temporal convergence is considered as the first trajectory, wherein a trajectory after the frame of the spatio-temporal convergence is considered as the second trajectory;
estimating, by the electronic device, a hand pose by encoding the two extrapolated hand landmarks of the spatio-temporal convergence; and
recognizing, by the electronic device, the at least one hand gesture, based on a sequence of hand pose information.

9. An electronic device, comprising:
a memory storing at least one instruction; and,
at least one processor configured to execute the at least one instruction stored in the memory;
wherein the at least one processor is configured to execute the at least one instruction to:
track a visible trajectory of a hand of the user from a plurality of frames captured by the electronic device, wherein the plurality of frames comprise a first frame, a second frame, one or more frames captured before the first frame, and one or more frames captured after the second frame;
identify the first frame, where the hand of the user has gone out of a Field of View (FOV) of the electronic device, among the plurality of frames;
identify the second frame, where the hand of the user has come back into the FOV of the electronic device, among the plurality of frames;
obtain, using an Artificial Intelligence (AI) model, a trajectory of the hand of the user using the one or more frames captured before the first frame among the plurality of frames, and the one or more frames captured after the second frame among the plurality of frames; and
recognize at least one hand gesture performed during the visible trajectory of the hand of the user, and the obtained trajectory of the hand of the user.

10. The electronic device as claimed in claim 9, wherein the at least one processor is configured to execute the at least one instruction to:
select a frame, among the plurality of frames, with the presence of the hand of the user from the visible trajectory; and
generate references of one or more hand landmarks from the frame with the presence of the hand of the user.

11. The electronic device as claimed in claim 10, wherein the at least one processor is configured to execute the at least one instruction to:
estimate a location of the one or more hand landmarks of the one or more frames captured before the first frame, based on the generated references of the one or more hand landmarks;
calculate one or more kinetic parameters of each hand landmark, using the estimated location of the one or more hand landmarks of consecutive frames, wherein the consecutive frames comprises the one or more frames captured before the first frame; and
obtain a first trajectory of the hand of the user using the one or more frames captured before the first frame, using the calculated one or more kinetic parameters of each of the one or more hand landmarks.

12. The electronic device as claimed in claim 10, wherein the at least one processor is configured to execute the at least one instruction to:
reverse the order of the plurality of frames captured by the electronic device;
estimate a location of the one or more hand landmarks of the one or more frames captured after the second frame, based on the generated references of the one or more hand landmarks;
calculate one or more kinetic parameters of each hand landmark, using the estimated location of the one or more hand landmarks of consecutive frames, wherein the consecutive frames comprises the one or more frames captured after the second frame; and
obtain a second trajectory of the hand of the user corresponding to the one or more frames captured after the second frame, using the calculated one or more kinetic parameters of each of the one or more hand landmarks.

13. The electronic device as claimed in claim 12, wherein the one or more kinetic parameters of the hand of the user comprise at least one of a velocity, and an acceleration of each of the one or more hand landmarks.

14. The electronic device as claimed in claim 12, wherein the at least one processor is configured to execute the at least one instruction to:
verify if the hand of the user is in the FOV of the electronic device, after calculating one or more kinetic parameters of each of the one or more hand landmarks; and
calculate a velocity and a position of the one or more hand landmarks in a next frame, of the plurality of frames and after the one or more frames captured after the second frame, using the calculated one or more kinetic parameters of each of the one or more hand landmarks, if the hand of the user is not in the FOV of the electronic device.

15. The electronic device as claimed in claim 14, wherein the at least one processor is configured to execute the at least one instruction to:
verify at least one parameter of the hand of the user, after calculating the velocity and the position of the one or more hand landmarks in the next frame, wherein the at least one parameter comprises at least one of whether a velocity goes to zero, a hand position is beyond a threshold, and the one or more hand landmarks no longer conform to predetermined bio-mechanical constraints of a human hand;
repeat a verification of the hand of the user in the FOV of the electronic device, if the at least one parameter of the hand of the user is not satisfied; and
repeat estimation of the location of the one or more hand landmarks from a previous frame, previous to the next frame, if the hand of the user is stationary and the at least one parameter of the hand of the user is satisfied.

16. The electronic device as claimed in claim 11, wherein the at least one processor is configured to execute the at least one instruction to:
check closeness of the one or more hand landmarks for each frame, of the plurality of frames, from the first trajectory and the second trajectory of the hand of the user;
obtain a spatio-temporal convergence at a frame, of the plurality of frames, where a distance between two extrapolated hand landmarks is below a certain threshold, wherein a trajectory until the frame of the spatio-temporal convergence is considered as the first trajectory, wherein a trajectory after the frame of the spatio-temporal convergence is considered as the second trajectory;
estimate a hand pose by encoding the two extrapolated hand landmarks of the spatio-temporal convergence; and
recognize the at least one hand gesture, based on a sequence of hand pose information.

17. A multi-camera device, comprising:
a memory; and,
at least one processor configured to execute the at least one instruction stored in the memory,
wherein the at least one processor is configured to execute the at least one instruction to:
obtain an outward trajectory for one or more frames where the hand of the user goes out of a Field of view (FOV) of the multi-camera device;
obtain an inward trajectory from one or more frames where the hand of the user comes back into the FOV of the multi-camera device, wherein the inward trajectory is predicted by reversing the order of the one or more frames where the hand of the user comes back into the FOV;
estimate a convergence point of the outward trajectory and the inward trajectory in temporal and spatial domains; and
recognize at least one hand gesture, based on a sequence of hand pose information obtained from the estimated convergence point, wherein a hand pose is estimated by encoding one or more extrapolated hand landmarks of the convergence point.

18. The multi-camera device according to claim 17,
wherein the at least one processor is configured to execute the at least one instruction to control an action to at least one of a video game and a user interface window depending on recognizing the hat least one hand gesture.
